(19) United States
(12) Patent Application Publication
(10) Pub. No.: US 2005/0275150 A1
(43) Pub. Date: Dec. 15, 2005

(54) Printer media transport for variable length media

(76) Inventors: Brian Dale Cook, Nicholasville, KY (US); William Scott Klein, Richmond, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/865,632

(22) Filed: Jun. 10, 2004

(51) Int. Cl. F16H 61/18; F16H 61/16; B65H 3/06

(52) U.S. Cl. 271/109

(57) ABSTRACT

Printer (1) has a pivotally mounted autocompensating system (19) mounted at an intermediate position in paper guide (17). That system (19) is driven by a motor (40) through a slip drive (70, 72, 74). The motor also drives paper feed system (15). When the motor turns in a direction to feed by system (15), the intermediate system is moved away from the paper guide. When a sheet reaches a position to be fed by the intermediate system, the motor is reversed, and the intermediate system pivots against the paper for moving it further through the paper guide.

### TECHNICAL FIELD

This invention relates to imaging devices that feed variable length media over a paper path longer than the length of some of the media to be fed.

### BACKGROUND OF THE INVENTION

Printing devices utilizing a media tray under the device typically feed the media out of the tray to the rear and around a “C” shaped path to enter the imaging area and exit to the front of the device. This provides a very compact machine. Because of the varying lengths of media fed through such a device, some mechanism must be provided to accommodate the discrepancy between the length of short media and the path length. This conventionally is done by using a relatively large drive roller (or rollers) which move the media toward non-driven idler rollers to maintain contact with the media while it is being fed around the path and into the imaging area.

### DISCLOSURE OF THE INVENTION

This invention employs in an intermediate location in the feed path a drive system which has been used successfully as the initial media pick-and-feed system from the tray. That mechanism is an autocompensting system, comprising one or more feed rollers on a swing arm pivoted around a gear train which drives the feed roller. Autocompensating systems are cost-effective and may be moved toward the media for feeding and off the media by reversing the torque to the gear train. An autocompensating system is also used to pick paper from the tray, and both autocompensating systems may be driven from one motor through different drive trains.

The intermediate autocompensating system is moved away from the feed path until media is driven past that system. Then that system is applied to move the media while the tray autocompensating system is not driven.

### BRIEF DESCRIPTION OF THE DRAWINGS

The details of this invention will be described in connection with the accompanying drawings, in which

FIG. 1 is a printer and is illustrative of a long, C-shaped path between a paper tray and the imaging printhead,

FIG. 2 is a partial, somewhat more detailed, perspective view downward on the tray and the front guide.

FIG. 3 is a view from the same side as the view of FIG. 2 of the motor and gear train to the autocompensating systems,

FIG. 4 is a view from the side opposite the view of FIG. 2 of motor and gear trains to the autocompensating systems.

FIG. 5 illustrates the autocompensating systems in some detail and the drive path between tray and nip roller preceding the imaging station.

FIG. 6 is a perspective view of selected elements to explain the slip drive, and

FIG. 7 is a perspective view of selected elements from the side opposite to that of FIG. 6 to explain the slip drive.

### DESCRIPTION OF THE PREFERRED EMBODIMENTS

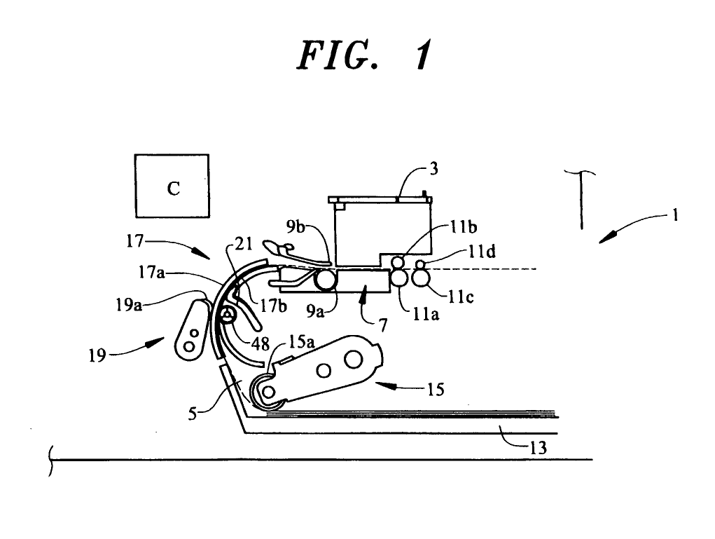

FIG. 1 is illustrative of a printer 1 with specific elements pertinent to this invention. Printer 1 may be a standard inkjet printer in most respects. As such it has a bottle printhead 3 which jets dots of ink through nozzles not shown, which are located above a sheet 5 of paper or other media at a imaging station 7

Imaging station 7 is located past nip rollers 9a, 9b which grasp paper 5 in the nip of rollers 9a, 9b and move it under printhead 3. Nip rollers 9a, 9b are stopped normally several times to permit printhead 3 to partially image sheet 5 by moving across sheet 5 (in and out of the view of FIG. 1) while expelling dots in the desired pattern. In a draft mode the number of such intermittent stops may be only two, while in a quality mode that number may be five or more.

Nip rollers 9a, 9b push paper through the imaging station 7 where they enter exits rollers 11a, 11b, 11c, and 11d. Although rollers are by far the most common mechanism to transport the imaged sheet 5 out of the printer 1 to the user of the printer 1, virtually any grasping device can be used, such as a belt and pressing device or pneumatic suction device.

The printer of FIG. 1 has a paper tray 13 located on the bottom. Tray 13 constitutes a bin in which a stack of paper or other media sheets 5 are held to be imaged. Having tray 13 located on the bottom of printer 1 permits a large stack of sheets 5 to be in the printer 1. This spaces the tray 13 from the print stations 7, the distance from pick roller 15a of tray 13 to nip rollers 9a, 9b being longer than the length of some media sheets 5 to be printed. Pick roller 15a is a part of an autocompensating swing mounted system 15.

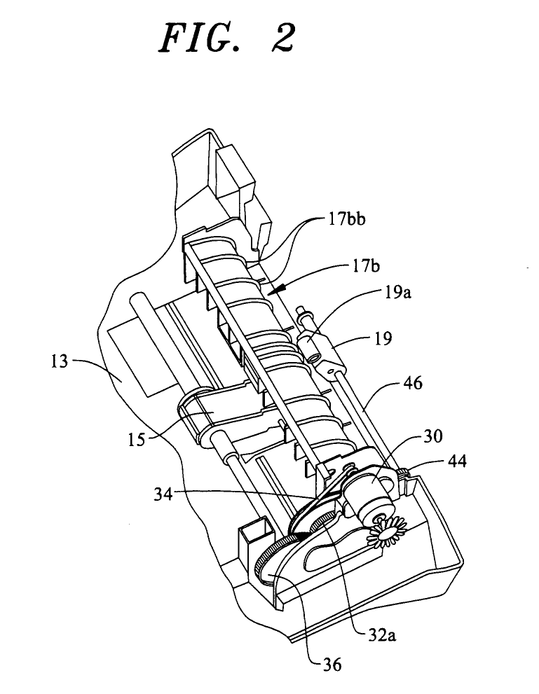

A C-shaped paper guide 17 is made up of rear guide surface 17a and spaced, generally parallel, front guide surface 17b. Both surfaces have spaced ridges (shown for surface 17b as 17bb in FIG. 2), as is common. Guide 17 directs a sheet 5 to nip rollers 9a, 9b. Intermediate in guide 17 is drive roller 19a, which is a part of an autocompensating swing-mounted system 19. Sensor arm 21 is moved by a sheet 5 to detect the sheet 5 at system 19.

Pick roller 15a at tray 13 and drive roller 19a combine to move sheets 5 from tray 13 to nip rollers 9a, 9b. Drive roller 19a is effective to move short media into rollers 9a, 9b, when pick roller 15a is no longer in contact with the sheet 5.

Operational control is by electronic data processing apparatus, shown as element C in FIG. 1. Such control is now entirely standard. A standard microprocessor may be employed, although an Application Specific Integrated Circuit (commonly known as an ASIC) is also employed, which is essentially a special purpose computer, the purpose being to control all actions and timing of printer 1. Electronic control is so efficient and versatile that mechanical control by cams and relays and the like is virtually unknown in imaging. However, such control is not inconsistent with this invention.

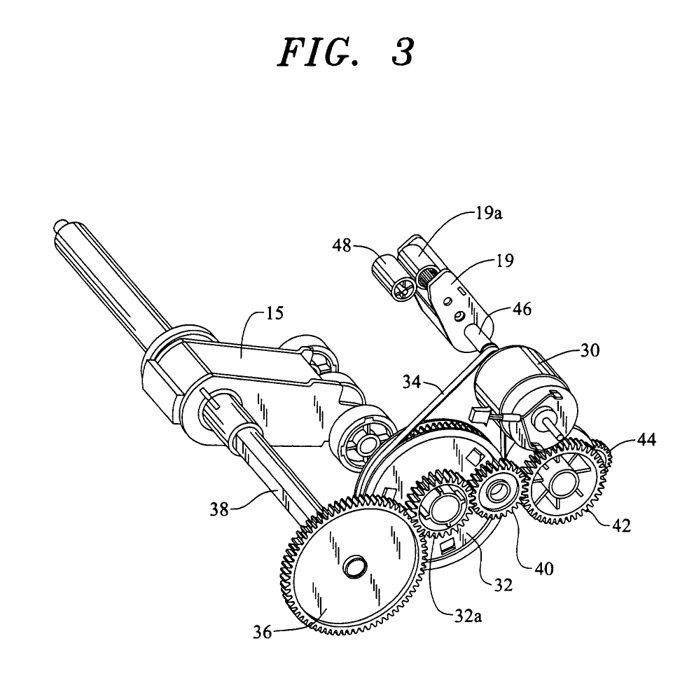

Movement of parts in the printer shown in FIGS. 2, 3 and 4 is by one motor. With respect to FIG. 3 motor 30 is seen to drive a large gear 32 through a belt 34. Gear 32 has integral with it a central, smaller gear 32a. The gear 32 is meshed with large gear 36, which is integral with shaft 38 to provide torque to autocompensating system 15.

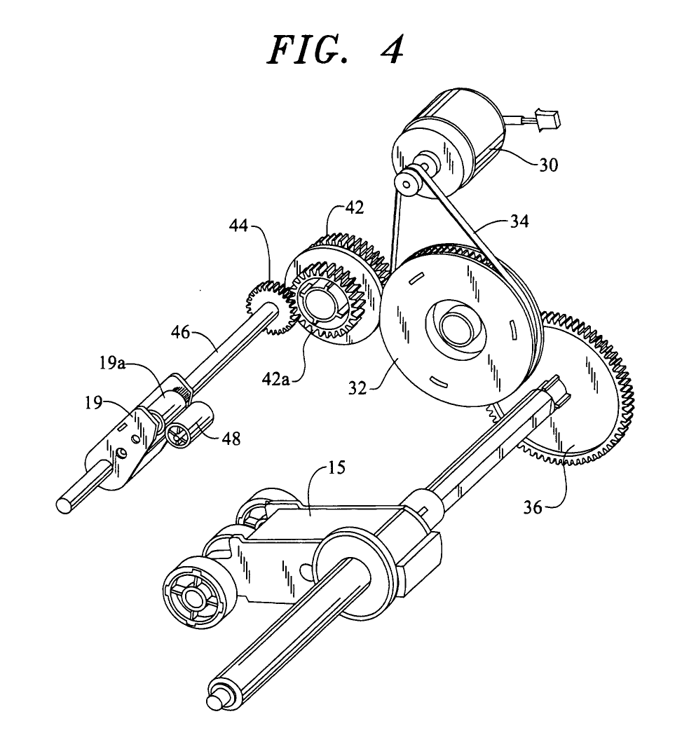

Similarly, gear 32a meshes with idler gear 40 which meshes with a somewhat larger gear 42. Gear 42 has integral with it a central, smaller gear 42a (best seen in FIG. 4). Gear 42a is meshed with gear 44, which is integral with splined shaft 46 to provide torque to autocompensating system 19

As is evident from the gears trains, rotation of motor 30 counterclockwise as viewed in FIG. 3 applies a downward torque (as discussed below) to autocompensating system 15 and an upward torque (as discussed below) to autocompensating system 19. Rotation of motor 30 clockwise reversed the direction of torque to both system 15 and system 19.

FIGS. 3 and 4 also illustrate a roller 48, which is mounted to roll free, which drive roller 19a contacts when driving should no media sheet 5 be under roller 19a, which avoids a high downward torque being generated. With respect to roller 15a in the tray 13, no comparable apparatus to roller 48 is used as the high torque can be used to signal absence of paper and therefore to terminate drive to autocompensating system 15.

The autocompensating systems 15 and 19 of this embodiment are not novel with respect to their design and function A slip drive closely similar to that employed has been sold in a prior art device of the assignee of this invention. However, that was employed to lift the paper feed autocompensation system off the paper stack after the top sheet is fed a predetermined distance. This invention employs the slip drive with the autocompensating system located in the paper guide 17.

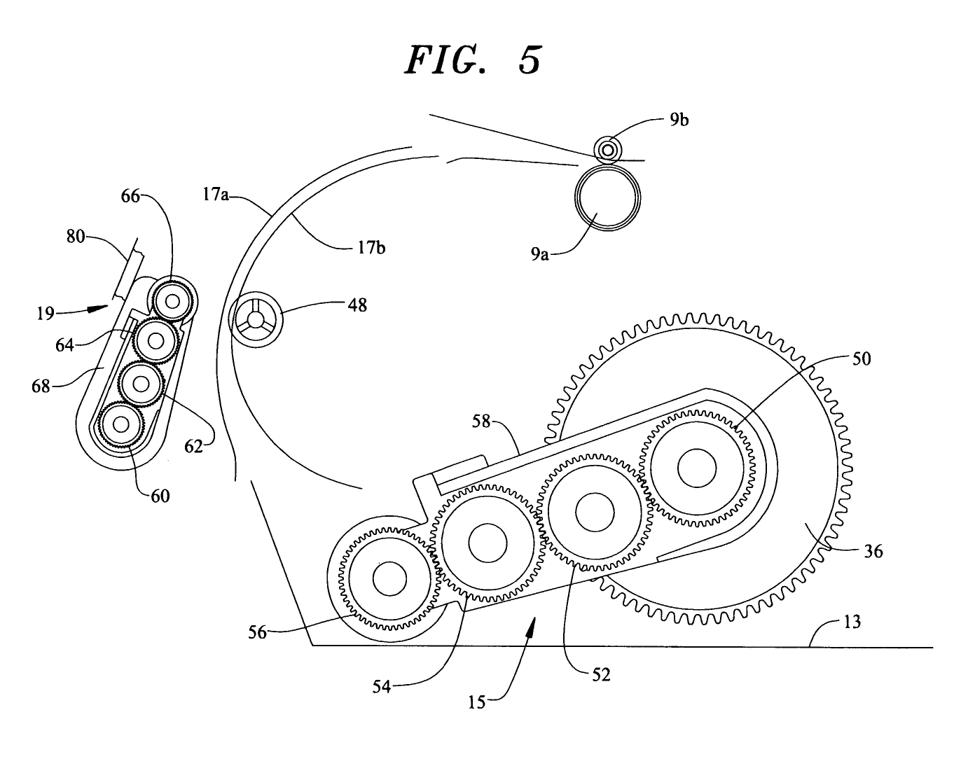

With reference to FIG. 5, autocompensating system 15 is seen to have four meshed gears 50, 52, 54 and 56 each meshed to the next gear in a linear train and supported within a bracket 58. Gear 56 is integral with drive roller 15a so that it moves both by pivoting (when gear 56 pivots) and by rotation (when gear 56 rotates). Gear 50 on the opposite end of the train of gears 50, 53, 54, and 56 is rotated by shaft 38 (FIGS. 2, 3 and 4). Similarly for autocompensating system 19 gears 60, 62, 64 and 66 are each meshed to the next gear in a linear train and supported within a bracket 68. Gear 66 is integral with drive roller 19a so that it moves both by pivoting (when gear 66 pivots) and by rotation (when gear 66 rotates).

Assuming counterclockwise torque to gear 50 and clockwise torque to gear 60, so long as gear 56 of system 15 or gear 66 of system 19 is not rotating, the torque pivots bracket 58 or bracket 68 respectively and the force against a sheet 5 of drive roller 15a and 19a increases toward the maximum pivoting force which can be applied by motor 30. This force is immediately relieved when gear 56 rotates in the case of system 15 and when gear 66 rotated in the case of system 19. Such rotation occurs when a sheet 5 is being moved, and it is the increase in pivot force against the sheet until it is moved which constitutes autocompensating in the systems.

Opposite or no rotation from the feeding rotation of gears 50 and 60 relieve pivoting torque because the direction of pivot is away from the feeding position and therefore the gears 56 and 66 respectively are free to rotate. To prevent such rotation with respect to system 15, gear 50 is driven through a one-way clutch, (not shown), which may be a conventional ball-and-unsymmetrical-notch clutch or other clutch.

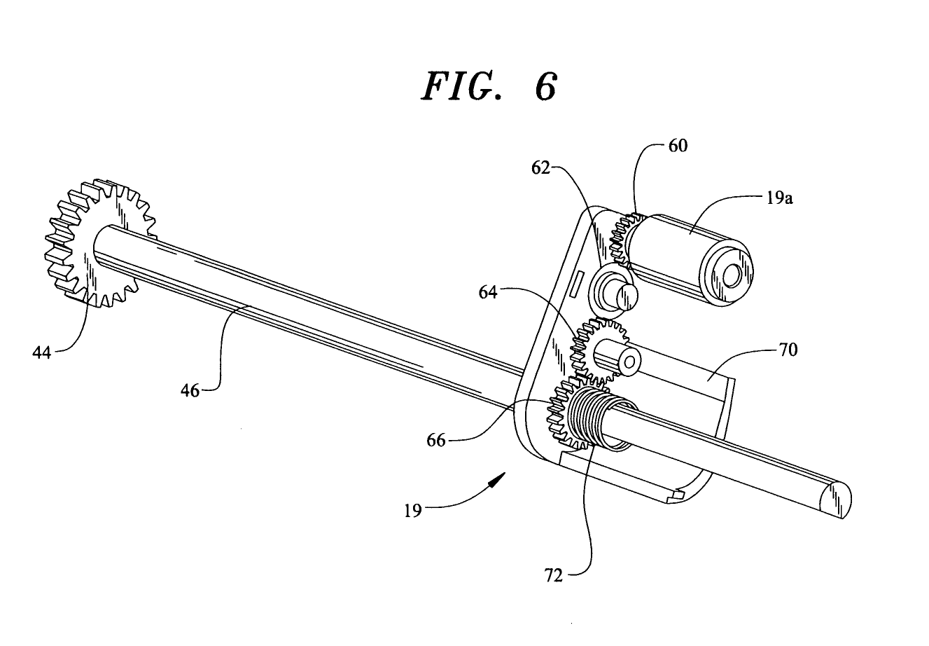

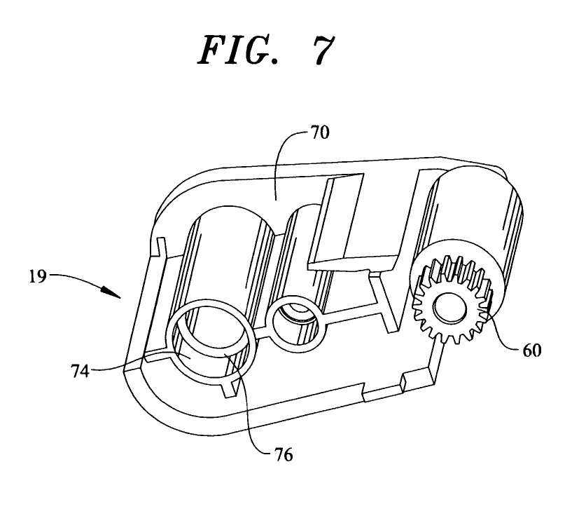

FIG. 5 shows autocompensation system positively moved away from the guide 17. This occurs when gear 60 is driven in the direction opposite to sheet feed. To achieve that, an added mechanism is applied to the autocompensation system 15, which is illustrated in FIG. 6 and FIG. 7.

This mechanism is a slip drive. As shown in FIG. 6, within the housing 70 of autocompensating system 19 is a coil spring 72 mounted on drive shaft 46 and having one side in contact with the face of gear 66.

As shown in FIG. 7, housing 70 has a cylindrical well 74 with bottom face 76 which receives the side of spring 72 (FIG. 6) opposite to that which faces gear 66. The dimensions of well 74 are such that spring 72 is compressed.

With spring 72 compressed, the turning of gear 66 turns spring 72 and the turning of spring 72 tends to rotate the entire housing 70, since well 74 is integral with housing 70. However, when further rotation is blocked, spring 72 simply slips.

When gear 66 is rotated in the reverse feeding direction, system 19 is moved away from the drive path of guide 17 as shown in FIG. 5, where it is stopped by being blocked by a fixed member 80, which may be integral with the structure forming guide 17.

When gear 66 is rotated in the feeding direction, spring 72 adds somewhat to the downward force while slipping.

In operation, under control of controller C, motor 30 is driven to feed a sheet 5 from tray 13 by rotating autocompensating system 15 downward. Autocompensating system 19 is necessarily driven by the slip drive to move away from the paper feed direction. Accordingly, when a sheet 5 is being moved by system 15, system 19 is moved completely out of guide path 17, as shown in FIG. 4.

In normal operation, the sheet 5 moves to encounter sensor arm 21 (FIG. 1). Then the controller C reverses motor 30. The direction of rotation of motor 30 is reversed, causing autocompensating system 19 to pivots to contact sheet 5, while autocompensating system 15 has no torque since the one-way clutch 9 (not shown), prevents any drive to autocompensating system 15.

System 19 moves sheets 5 until they reach nip roller 9a, 9b and, preferably, become somewhat buckled. The buckling serves to align sheets 5. The remaining imaging operation may be entirely standard.

It will be recognized that this invention can take many mechanical forms, so long as an autocompensating system is used at least at the intermediate drive location.

1. An imaging device comprising
an imaging station,
a sheet media tray spaced from said imaging station,
a media guide path between said imaging station and said media tray
a media drive member to move sheet media from said sheet media tray into said paper guide path,
a pivotally mounted first autocompensating system located in said paper guide path for driving media, and
a motor to provide torque to said autocompensating system.

2. The imaging device as in claim 1 in which said first autocompensating system comprises a slip drive from said motor operative to move said first autocompensating system away from said media guide path when said motor is rotating to provide torque to said first autocompensating system opposite to torque for media feed in said guide by said first autocompensating system.

3. The imaging device as in claim 2 also comprising a second pivotally mounted autocompensating system to feed media from said sheet media guide through said media guide path at least to a location at which said first autocompensating system can feed said media.

4. The imaging device as in claim 3 also comprising a media-presence sensor located to sense media fed in said sheet media guide to a location to be fed by said first autocompensating system, said motor also providing torque to said second autocompensating system.

5. The method performed with the apparatus of claim 4 comprising the steps of feeding media from said tray through said guide while operating said motor to provide torque to said first autocompensating system to move said first autocompensating system away from said media path, sensing said media presence with said sensor, and then operating said motor to provide torque to said first autocompensating system to feed media by said first autocompensating system.

6. An imaging device comprising
an imaging station,
a sheet media tray spaced from said imaging station,
a media guide path between said imaging station and said media tray,
a pivotally mounted first autocompensating system located in said paper guide path for driving media,
a pivotally mounted second autocompensating system to feed media from said sheet media tray through said media guide path at least to a location at which said first autocompensating system can feed said media, and
a motor to provide torque to said first autocompensating system and said second autocompensating system.

7. The imaging device as in claim 6 in which said first autocompensating system comprises a slip drive from said motor operative to move said first autocompensating system away from said media guide path when said motor is rotating to provide torque to said first autocompensating system opposite to torque for media feed in said guide by said first autocompensating system.

8. The imaging device as in claim 4 also comprising a media-presence sensor located to sense media fed in said sheet media guide to a location to be fed by said first autocompensating system.

9. The method performed with the apparatus of claim 7 comprising the steps of feeding media from said tray through said guide while operating said motor to provide torque to said first autocompensating system to move said first autocompensating system away from said media path, sensing said media presence with said sensor, and then operating said motor to provide torque to said first autocompensating system to feed media by said first autocompensating system.
